(19) United States
(12) Patent Application Publication
(10) Pub. No.: US 2015/0295656 A1
(43) Pub. Date: Oct. 15, 2015

(54) SECURE OPTICAL REPEATER AND HOUSINGS THAT MAY BE USED TO HOUSE THE OPTICAL REPEATER

(71) Applicant: Avago Technologies General IP (Singapore) Pte.Ltd., Singapore (SG)

(72) Inventor: Masaki Ono, Regensburg (DE)

(21) Appl. No.: 14/556,293

(22) Filed: Dec. 1, 2014

Related U.S. Application Data
(63) Continuation-in-part of application No. 14/287,330, filed on May 27, 2014, now abandoned.
(60) Provisional application No. 61/979,502, filed on Apr. 14, 2014.

(51) Int. Cl. H04B 10/29

(52) U.S. Cl. CPC H04B 10/29

(57) ABSTRACT

An optical repeater is provided that is secure in terms of preventing unauthorized access to the electrical signals produced in the receiver portion of the repeater. In addition, the optical repeater is relatively small in size and economical to manufacture. A leadframe of the repeater is bent into a first leadframe portion on which a first optical-to-electrical (OE) converter is mounted and a second leadframe portion on which a first electrical-to-optical (EO) converter is mounted. The leadframe has a data lead that is electrically coupled to the output of the OE converter of the receiver portion and to the input of the EO converter of the transmitter portion. Housings for housing the optical repeater and other types of optical devices are also provided. The data lead is encapsulated in the housing so that unauthorized access to the electrical signals carried on it is not possible.

### CROSS-REFERENCE TO RELATED APPLICATIONS

This application is a continuation-in-part (CIP) of and claims priority to U.S. application Ser. No. 14/287,330, filed on May 27, 2014, entitled “A SECURE OPTICAL REPEATER AND A METHOD,” which is hereby incorporated by reference herein in its entirety, and is a nonprovisional application of and claims priority to provisional application Ser. No. 61/979,502, filed on Apr. 14, 2014, entitled “A SECURE OPTICAL PORT,” which is also hereby incorporated by reference herein in its entirety.

### TECHNICAL FIELD OF THE INVENTION

The invention relates to optical communications. More particularly, the invention relates to an optical repeater for performing optical-to-electrical-to-optical conversion and to housings that may be used to house the optical repeater.

### BACKGROUND OF THE INVENTION

In optical communications systems and networks, optical fiber cables are used to interconnect components and to carry optical signals between the components. Optical transmitters, receivers and transceivers are used to transmit and receive the optical signals. An optical repeater is a component that is sometimes used in optical communications networks to receive an optical signal being carried on an optical fiber, convert the received optical signal into an electrical signal, convert the electrical signal back into an optical signal, and transmit the optical signal over an optical fiber. This process of performing optical-to-electrical-to-optical conversion is sometimes referred to as regeneration, and optical repeaters are sometimes referred to as optical regenerators. Optical repeaters are often used to extend the reach of an optical communications network by regenerating optical signals that have been degraded due to attenuation and/or distortion.

One of the disadvantages of many optical repeaters is that they often are relatively large in size. A typical optical repeater has an optical receiver, an optical transmitter, and some type of optics system, all of which are packaged in some type of hard package. In the receiver portion of the repeater, the optics system couples light between the end of the optical fiber and the optical-to-electrical (OE) converter of the receiver. In the transmitter portion of the repeater, the optics system couples light between the electrical-to-optical (EO) converter and the end of the optical fiber. The receiver portion typically includes the OE converter (e.g., a photodiode), a transimpedance amplifier (TIA), a receiver integrated circuit (IC), and a leadframe or a circuit board on which these components are mounted. The transmitter portion typically includes the EO converter (e.g., a laser diode or light-emitting diode (LED)), a driver IC and a leadframe or circuit board on which these components are mounted. In some cases, components of the receiver and transmitter portions are mounted on the same leadframe or circuit board. Due to the number of these components that are contained in the package and the arrangement of the components in the package, optical repeaters tend to be relatively large in size.

Another disadvantage of many optical repeaters is that they generally do not provide protection against unauthorized access to the electrical signals that are produced in the receiver portion of the repeater. The data pin on which the electrical signal is carried before being converted back into an optical signal is typically exposed outside of the repeater package for connection to a circuit board over which the electrical signal is transferred to the transmitter portion of the repeater. This allows unauthorized access to the electrical signal, which can raise security concerns.

Accordingly, a need exists for such an optical repeater that is relatively small in size, economical to produce, and secure in terms of preventing unauthorized access to the electrical signals that are produced in the receiver portion of the repeater.

### SUMMARY OF THE INVENTION

The invention is directed to a secure optical repeater and various housings that may be used to for house the optical repeater. The optical repeater comprises a bent leadframe having first and second leadframe portions, at least a first optical-to-electrical (OE) converter mounted on the first leadframe portion, at least a first electrical-to-optical (EO) converter mounted on the second leadframe portion, a first optical port secured to the first leadframe portion and facing the front side of the repeater, a second optical port secured to the second leadframe portion and facing a back side of the repeater, and a housing.

The first optical port for receives a first optical signal passing out of an end of a first optical fiber cable and directs the first optical signal onto the first OE converter. The first OE converter converts the first optical signal into a first electrical signal and outputs the first electrical signal over a data lead of the bent leadframe. The first EO converter device receives the first electrical signal via the data lead and converts the first electrical signal into a second optical signal. The second optical port directs the second optical signal into an end of a second optical fiber cable.

In accordance with an illustrative embodiment, the housing houses at least one optical communications device and comprises a first passageway, or receptacle, and a second passageway, or receptacle. The first receptacle is formed in a first side of the housing for allowing an end of a first optical fiber cable to be passed through the housing and connected with a first optical port of at least one optical communications device. The second receptacle is formed in a second side of the housing for allowing an end of a second optical fiber cable to be passed through the housing and connected with a second optical port of said at least one optical communications device. The first and second receptacles have first and second different-pluggability features, respectively. The first different-pluggability feature allows the first optical connector to be mated with the first receptacle. The second different-pluggability feature prevents the first optical connector from mating with the second receptacle.

In accordance with another embodiment, the housing is an integrally-formed plastic housing for housing at least one optical communications device. The housing comprises first and second receptacles. The first receptacle is formed in a first side of the housing for allowing a first optical connector to be connected to the first receptacle. The first optical connector is secured to an end of a first optical fiber cable. The first receptacle includes first and second flexible arms having first and second ends for engaging a first ridge feature of a first ferrule of the first optical connector. The second receptacle is formed in a second side of the housing and allows a second optical connector to be connected to the second receptacle. The second optical connector is secured to an end of a second optical fiber cable. The second receptacle includes third and fourth flexible arms having third and fourth ends for engaging a second ridge feature of a second ferrule of the second optical connector.

These and other features and advantages of the invention will become apparent from the following description, drawings and claims.

### BRIEF DESCRIPTION OF THE DRAWINGS

FIG. 1A illustrates a top perspective view of an optical repeater in accordance with an illustrative embodiment.

FIGS. 1B-1D illustrate top, front and side plan views, respectively, of the optical repeater shown in FIG. 1A.

FIG. 2 illustrates a front plan view of a first leadframe portion of a leadframe of the optical repeater shown in FIGS. 1A-1D.

FIG. 3 illustrates a back plan view of a second leadframe portion of the leadframe of the optical repeater shown in FIGS. 1A-1D.

FIG. 4 illustrates a side plan of a housing that houses the optical repeater shown in FIGS. 1A-1D.

FIG. 5 illustrates a top plan view of the leadframe shown in FIGS. 2 and 3 before it is bent.

FIG. 6A illustrates a top plan view of a housing that is essentially identical to the housing shown in FIG. 4 except that it has receptacles that are designed to mate with different types of optical plugs, or connectors, as will be described below in detail.

FIG. 6B illustrates a cross-sectional side view of the housing shown in FIG. 6A taken along line A-A′.

FIG. 7 illustrates a side plan view of an optical connector having a design that allows it to mate with one, but not both, of the receptacles of the housing shown in FIGS. 6A and 6B.

FIGS. 8A and 8B illustrate top and side views, respectively, of a housing in accordance with another illustrative embodiment that can be used to house the optical repeater shown in FIGS. 1A-1D.

FIG. 9A illustrates a top view of a housing in accordance with another illustrative embodiment that can be used to house the optical repeater shown in FIGS. 1A-1D.

FIG. 9B illustrates a side cross-sectional view of the housing shown in FIG. 9A taken along line B-B′.

FIGS. 10 and 11 illustrate top plan views of first and second optical connectors that are designed, or configured, to mate with first and second receptacles, respectively, of the housing shown in FIGS. 9A and 9B.

### DETAILED DESCRIPTION OF AN ILLUSTRATIVE EMBODIMENT

In accordance with the illustrative, or exemplary, embodiments, an optical repeater is provided that is secure in terms of preventing unauthorized access to the electrical signals produced in the receiver portion. In addition, the optical repeater is relatively small in size and economical to manufacture. In accordance with an illustrative embodiment, a single leadframe is used for mounting components and making electrical interconnections in the receiver and transmitter portions. The leadframe is bent into a first leadframe portion on which the receiver components are mounted and a second leadframe portion on which the transmitter components are mounted. The leadframe has a data lead that is electrically coupled to the output of the OE converter of the receiver portion and to the input of the EO converter of the transmitter portion. The data lead is encapsulated in the housing of the optical repeater so that it is inaccessible, thereby preventing an unauthorized user from gaining access to the electrical signals being carried on the data lead. The only leads that are exposed outside of the housing are electrical power and electrical ground leads. Using a single leadframe for the receiver and transmitter portions allows the optical repeater to be made more compactly and at lower costs.

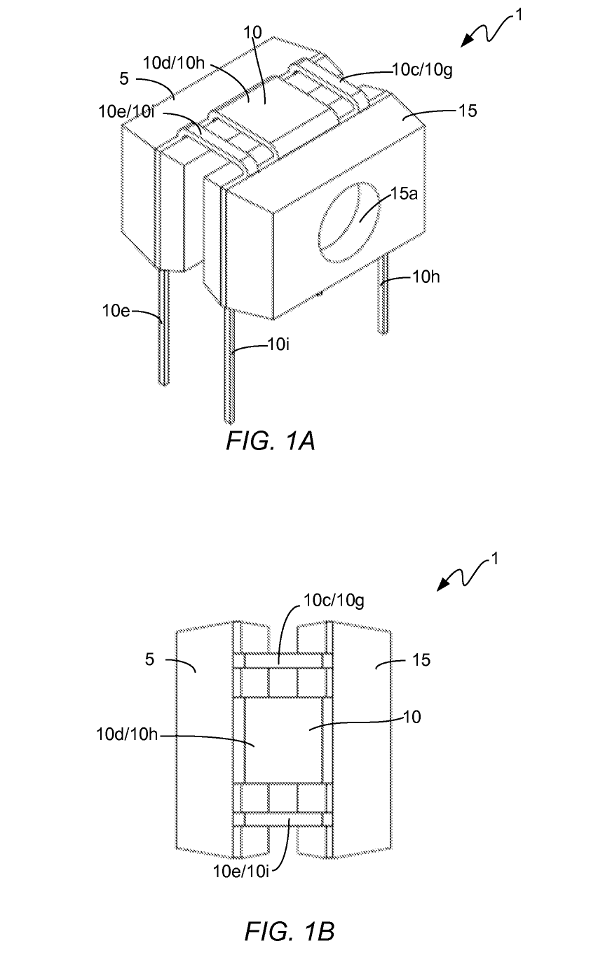

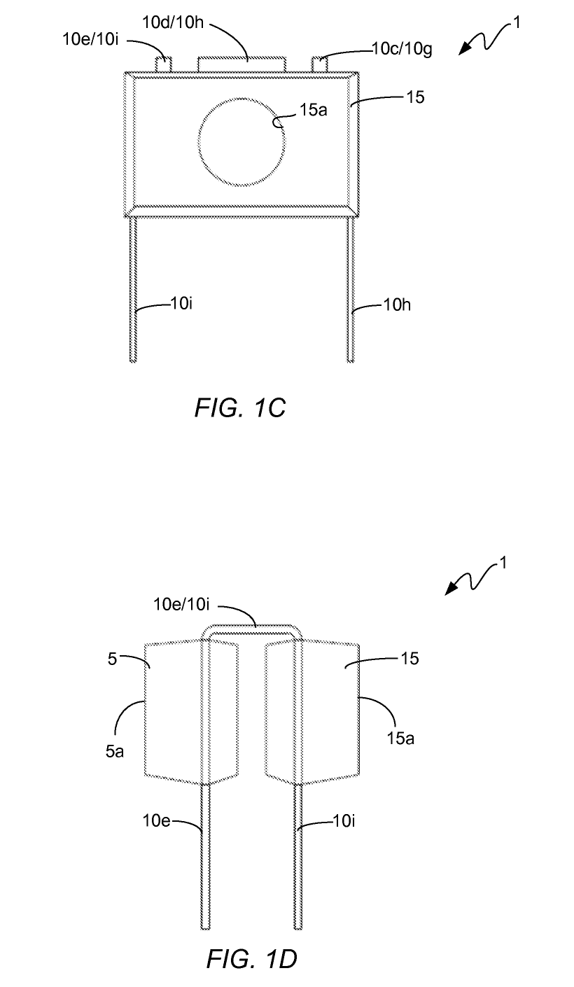

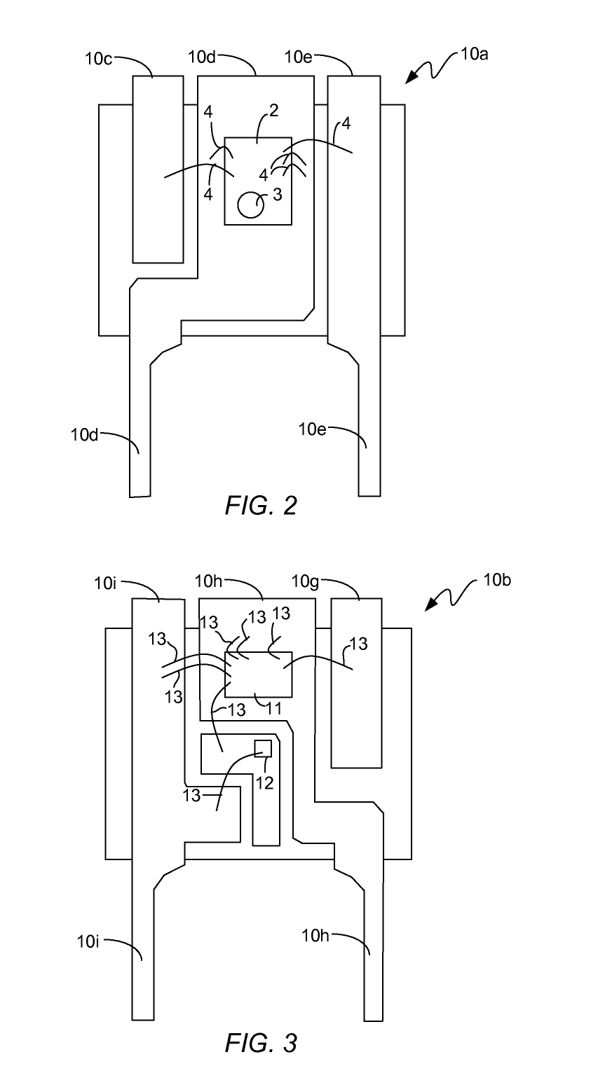

Illustrative embodiments of the optical repeater will now be described with reference to FIGS. 1A-11, in which like reference numerals represent like features, elements or components. It should be noted that features, elements or components shown in the figures are not necessarily drawn to scale. FIG. 1A illustrates a perspective view of the optical repeater 1 in accordance with an illustrative embodiment. FIGS. 1B-1D illustrate top, back and side plan views, respectively, of the optical repeater 1 shown in FIG. 1A. FIG. 2 illustrates a front plan view of a first leadframe portion 10a of a leadframe 10 of the optical repeater 1 shown in FIGS. 1A-1D. FIG. 3 illustrates a back plan view of a second leadframe portion 10b of the leadframe 10 of the optical repeater shown in FIG. 2.

The leadframe 10 is bent to form first and second leadframe portions 10a (FIGS. 2) and 10b (FIG. 3), respectively, that are generally parallel to one another. Making the first and second leadframe portions 10a and 10b parallel to one another allows the optical repeater 1 to be very compact. It should be noted, however, that it is not necessary for the first and second leadframe portions 10a and 10b to be precisely parallel to one another. The first leadframe portion 10a is part of the receiver portion of the optical repeater 1 and has one or more electric and/or optoelectronic components mounted thereon. For illustrative purposes, the first leadframe portion 10a is shown as having only a receiver IC 2 mounted thereon. The receiver IC 2 includes an OE converter 3, which is a photodiode in the illustrative embodiment. The first leadframe portion 10a has a data lead 10c, a ground lead 10d and a power lead 10e. The receiver IC 2 is connected by bond wires 4 to the data lead 10c, to the ground lead 10d and to the power lead 10e. The receiver IC 2 is mounted on a mounting area that is connected to the ground lead 10d. A molded plastic part 5 (FIGS. 1A, 1B and 1D) encapsulates portions of the first leadframe portion 10a, including portions of the leads 10c-10e and the receiver IC 2.

The second leadframe portion 10b (FIG. 3) is part of the transmitter portion of the optical repeater and has one or more electric and/or optoelectronic components mounted thereon. For illustrative purposes, the second leadframe portion 10b is shown as having only a driver IC 11 and an EO converter 12 mounted thereon. The EO converter 12 is an LED in the illustrative embodiment, but could instead be a laser diode or some other EO element. The second leadframe portion 10b has a data lead 10g, a ground lead 10h and a power lead 10i. The driver IC 11 is connected by bond wires 13 to the data lead 10g, to the ground lead 10h and to the power lead 10i. The LED 12 is connected by bond wires 13 to the power lead 10i and to the driver IC 11. The driver IC 11 is mounted on a mounting area that is connected to the ground lead 10h. A molded plastic part 15 (FIGS. 1A-1D) encapsulates portions of the second leadframe portion 10b, including portions of the leads 10g-10i, the driver IC 11 and the LED 12.

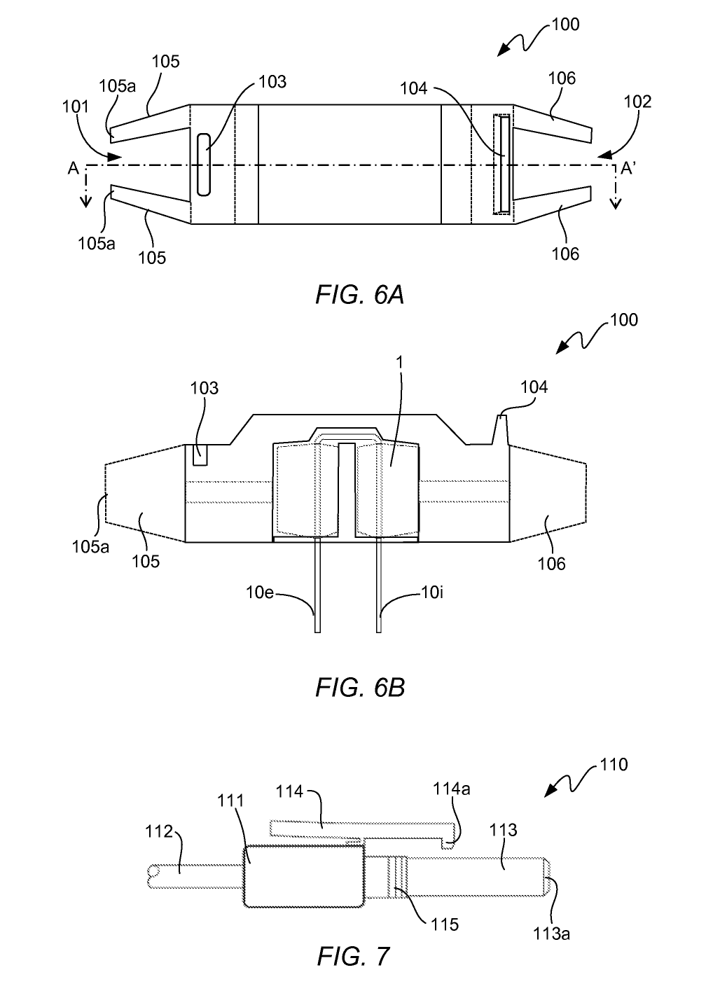

The molded plastic parts 5 and 15 are transparent to operating wavelengths of the OE and EO converters 3 and 12, respectively. The molded plastic parts 5 and 15 have openings 5a and 15a formed therein, respectively, that are shaped and sized to receive ends of respective optical fiber cables, as will be described below in more detail with reference to FIGS. 6A-11. In accordance with this illustrative embodiment, the openings 5a and 15a are aligned with the OE and EO converters 3 and 12, respectively, so that light is coupled between the ends of the respective optical fiber cables and the OE and EO converters 3 and 12. Thus, the molded plastic parts 5 and 15 having the openings 5a and 15a formed therein, respectively, constitute optical ports of the optical repeater 1. It is not necessary for the openings 5a and 15a to be aligned with the OE and EO converters 3 and 12, respectively, as long as one or more optical elements (e.g., reflectors or lenses) are included in the optical repeater 1 and arranged in such a way that light passing out of the fiber end connected to opening 5a is directed onto OE converter 3 and light produced by the EO converter 12 is directed into the fiber end connected to opening 15a.

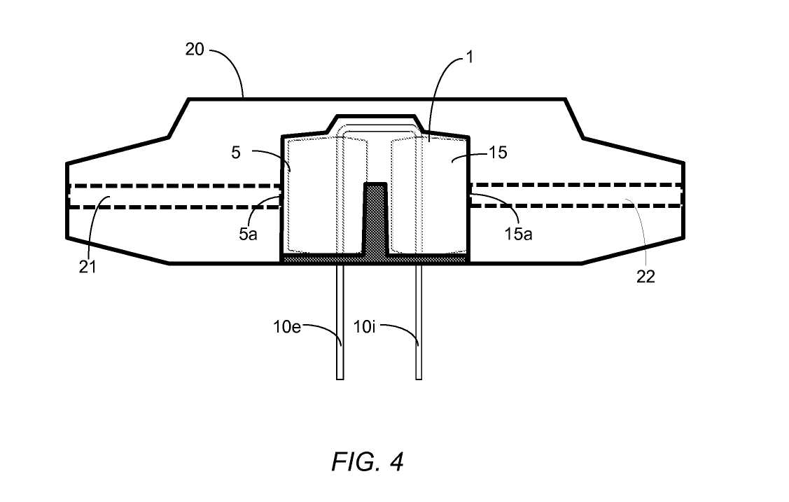

FIG. 4 illustrates a side plan of an illustrative embodiment of a housing 20 that may be used to house the optical repeater 1 shown in FIGS. 1A-1D. The housing 20 of the optical repeater 1 completely encapsulates the optical repeater 1 except for ends of the power and ground leads 10d, 10e, 10h, and 10i. The housing 20 is typically made of a hard plastic material. To provide electromagnetic interference (EMI) shielding, the plastic material of which the housing 20 is made is typically either an electrically-conductive plastic material or an electrically-nonconductive plastic material having a metal EMI shielding part embedded therein. Passageways 21 and 22 formed in opposite sides of the housing 20 allow the ends of the optical fiber cables (not shown) to be connected to the openings 5a and 15a, respectively. The ends of the cables are typically terminated by connectors having ferrules that hold the ends of the optical fibers, which are typically polished such that the fiber end faces are flush with the ends of the respective ferrules.

The data leads 10c and 10g (FIGS. 2 and 3), which carry the aforementioned electrical signals, are also completely encapsulated in the housing 20. Thus, there is no way for an unauthorized person to gain access to these electrical signals without breaking apart the housing 20. Another advantage of the optical repeater 1 is that because the openings 5a and 15a are on opposite sides of the repeater 1, the repeater 1 can be used as an outlet that can be secured to a wall or a chassis to allow the optical fiber cables to be inserted into the openings 5a and 15a from opposite sides of the wall or chassis. This also allows the repeater 1 to be more compact than existing repeaters that have both the openings on the same side of the repeater.

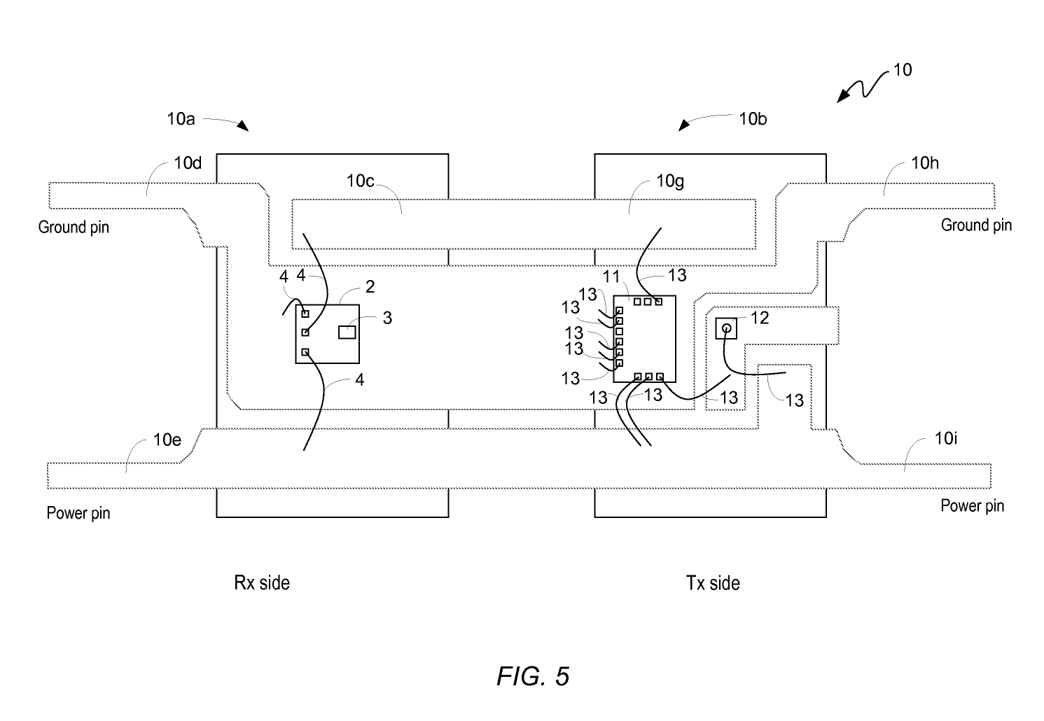

FIG. 5 illustrates a top plan view of the leadframe 10 shown in FIGS. 2 and 3 before it is bent. The process of assembling the optical repeater 1 will now be described with reference to FIGS. 1A-5. Typically, a plurality of the leadframes 10 are connected together at the beginning of the assembly process and the leadframes 10 are flat, as shown in FIG. 5. For ease of illustration, a single leadframe 10 is shown in FIG. 5. A die attach process is then performed to attach the components 2, 11 and 12 to the leadframes 10. The molded plastic parts 5 and 15 shown in FIGS. 1A-1D are then molded onto the first and second leadframe portions 10a and 10b. The leadframes 10 having the molded plastic parts 5 and 15 secured thereto are then singulated, or separated, from one another. The leadframes 10 are then bent into the shape shown in FIGS. 1A-1D and inserted into the housing 20 shown in FIG. 4.

FIG. 6A illustrates a top plan view of a housing 100 that is essentially identical to the housing 20 shown in FIG. 4 except that the housing 100 has receptacles that are designed to mate with different types of optical plugs, or connectors, as will be described below in detail. FIG. 6B illustrates a cross-sectional side view of the housing 100 shown in FIG. 6A taken along line A-A′ Like the housing 20, the housing 100 houses and completely encapsulates the optical repeater 1 (FIGS. 1A-1D) and the leadframe 10 except for ends of the power and ground leads 10d, 10e, 10h, and 10i. The data leads 10c and 10g, which carry the aforementioned electrical signals, are also completely encapsulated in the housing 100. Thus, there is no way for an unauthorized person to gain access to these electrical signals without breaking apart the housing 100. To provide EMI shielding, the housing 100 is typically made of a hard plastic material that is either an electrically-conductive plastic material or an electrically-nonconductive plastic material having a metal EMI shielding part embedded therein.

The housing 100 has first and second receptacles 101 and 102 formed in opposite sides thereof for receiving respective optical connectors (not shown) disposed on ends of optical fiber cables (not shown). In accordance with this illustrative embodiment, the receptacles 101 and 102 are designed to mate with different types of optical connectors such that the optical connector that is designed to be plugged into receptacle 101 cannot be plugged into receptacle 102, and vice versa. This feature of having different “pluggability” for the housing 100 ensures that only optical connectors, or plugs, having particular designs or configurations can be plugged into, or mated with, the receptacles 101 and 102. For example, assuming that receptacle 101 is the receiver side of the housing 100 and that receptacle 102 is the transmitter side of the housing 100, an optical connector having a first configuration or design that is connected to a transmitting optical cable (not shown) can be plugged into receptacle 101, but cannot be plugged into receptacle 102.

This different-pluggability feature can be achieved in a number of ways. In accordance with the illustrative embodiment of FIGS. 6A and 6B, the different-pluggability feature is achieved by providing a latch-mating feature 103 adjacent receptacle 101 and a latch-blocking feature 104 adjacent receptacle 102. The receptacles 101 and 102 have first and second pairs of flexible arms 105 and 106 that define the entrances to the receptacles 101 and 102, respectively. FIG. 7 illustrates a side plan view of an optical connector 110 having a design that allows it to mate with receptacle 101, but not with receptacle 102. The optical connector 110 is a standard type of optical connector used with a known family of Versatile Link (VL) components offered by the Assignee of the present application. The optical connector 110 has a plug body 111 secured to an end of an optical fiber cable 112, a ferrule 113 protruding from the plug body 111, and a latch 114 secured to a top surface of the plug body 111.

The receptacles 101 and 102 of the housing 100 are similar to receptacles of existing VL housings with respect to the manner in which they mate with optical connectors. Although the known VL components are available in a variety of types, the receptacle of the VL housing typically has a pair of flexible arms that are spaced apart and shaped to define an opening for receiving a ferrule of an optical connector. When optical connector is inserted into the receptacle, the arms flex outwardly to receive the ferrule and the ends of the arms latch with a ridge on the ferrule to prevent the connector from inadvertently being pulled out of the receptacle. The end of the ferrule is in abutment with a stop inside of the receptacle. The engagement of the ridge with the ends of the flexible arms and the abutment of the end of the ferrule with the stop inside of the receptacle restrain the movement of the optical connector. The receptacles 101 and 102 have this same configuration.

When the optical connector 110 is plugged into receptacle 101, the flexible arms 105 come into contact with the outer surface of the ferrule 113. The ends 105a of the arms 105 flex outwardly as they come into contact with a ridge 115 disposed on the ferrule 113 and then pass over the ridge 115, but remain in contact with the ridge 115. At this point of insertion of the ferrule 113 into the receptacle 101, the end 113a of the ferrule 113 is in abutment with the opening 5a (FIGS. 1A-1D) formed in the molded plastic body 5 of the optical repeater 1. In this way, movement of the optical connector 110 in the axial directions of the ferrule 113 is restrained. At this point of full insertion of the ferrule 113 into the receptacle 101, a latching mechanism 114a disposed on the end of the latch 114 of the optical connector 110 is engaged with the latch-mating feature 103 of the housing 100. The latch-mating feature 103 is an opening formed in the top surface of the housing 100 that is complementary in shape and size to the shape and size of the latching mechanism 114a such that the feature 114a is received in the opening 103. The engagement of features 103 and 114a further restrains movement of the optical connector 110 in the axial directions of the ferrule 113.

The latch-blocking feature 104 disposed on the top surface of the housing 100 adjacent receptacle 102 is an upwardly-directed stop. If an attempt is made to plug the optical connector 110 into receptacle 102, the latching mechanism 114a disposed on the end of the latch 114 will abut the upwardly-directed stop 104 to prevent insertion of the ferrule 113 into the receptacle 102. However, a different type of optical connector (not shown) that does not include the latch 114 may be mated with the receptacle 102. For example, an optical connector that is identical in shape and size to the optical connector 110 except that it does not include the latch 114 may be mated with the receptacle 102.

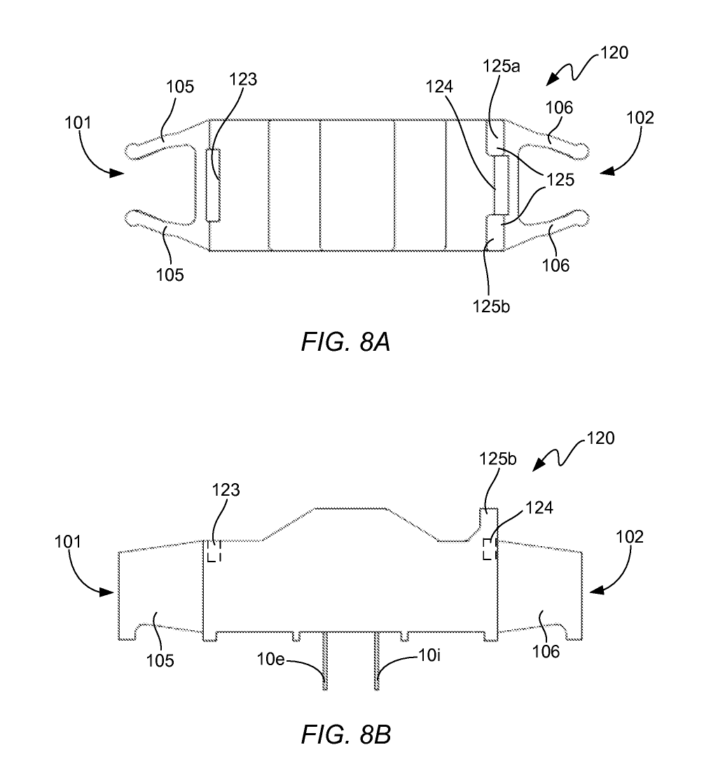

FIGS. 8A and 8B illustrate top and side views, respectively, of a housing 120 in accordance with another illustrative embodiment that can be used to house the optical repeater 1. The housing 120 is substantially identical to the housing 100 except that the manner in which the different-pluggability feature is achieved in housing 120 is different from the manner in which it is achieved in housing 100, as will be described below in detail.

Like the housings 20 and 100, the housing 120 houses and completely encapsulates the optical repeater 1 (FIGS. 1A-1D) and the leadframe 10 except for ends of the power and ground leads 10d, 10e, 10h, and 10i. The data leads 10c and 10g, which carry the aforementioned electrical signals, are also completely encapsulated in the housing 120. Thus, there is no way for an unauthorized person to gain access to these electrical signals without breaking apart the housing 120. To provide EMI shielding, the housing 120 is typically made of a hard plastic material that is either an electrically-conductive plastic material or an electrically-nonconductive plastic material having a metal EMI shielding part embedded therein.

In accordance with the illustrative embodiment of FIGS. 8A and 8B, the different-pluggability feature is achieved by providing a latch-mating feature 123 adjacent receptacle 101 and latch-mating and latch-blocking features 124 and 125, respectively, adjacent receptacle 102. The latch-mating feature 123 is an opening formed in the top surface of the housing 120 that is complementary in shape and size to the shape and size of the latching mechanism 114a of the optical connector 110 (FIG. 7) such that the latching mechanism 114a is received in the opening 123 when the connector 110 is fully engaged with receptacle 101. Thus, receptacle 101 can be mated with the optical connector 110 in the same manner as described above with reference to FIGS. 6A-7.

The latch-mating feature 124 adjacent receptacle 102 is an opening formed in the top surface of the housing 120 that is smaller in width than opening 123 for receiving a latching mechanism (not shown) that is smaller in width than the latching mechanism 114a. The latch-blocking feature 125 comprises two stops 125a and 125b disposed on opposite sides of the opening 124 and directed upwardly from the top surface of the housing 120. The stops 125a and 125b are separated from one another by an air gap having the same width as the width of the opening 124.

Because the opening 124 is smaller in width than the width of the opening 123, an optical connector that is identical to optical connector 110 (FIG. 7), but having a latch that is no wider than the distance between the stops 125a and 125b, can be mated with receptacle 102 in the same manner in which the latching mechanism 114a disposed on the end of the latch 114 is mated with the opening 123. However, if an attempt is made to mate the optical connector 110 with the receptacle 102, the latching mechanism 114a, which is wider than the distance between the stops 125a and 125b, will abut the stops 125a and 125b to prevent mating of the connector 110 with the receptacle.

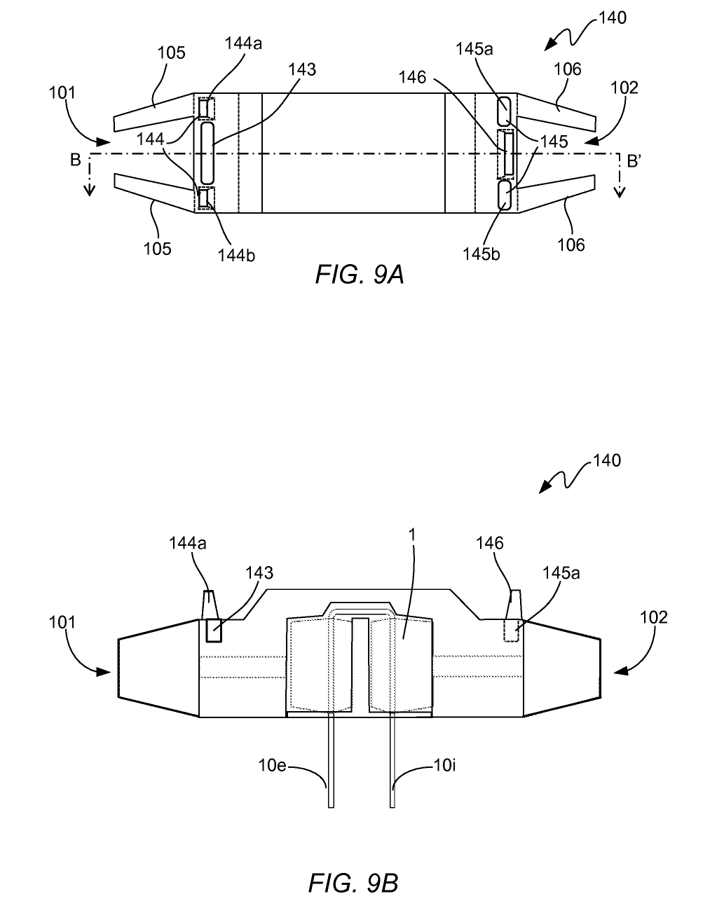

FIG. 9A illustrates a top view of a housing 140 in accordance with another illustrative embodiment that can be used to house the optical repeater 1. FIG. 9B illustrates a side cross-sectional view of the housing 140 shown in FIG. 9A taken along line B-B′. The housing 140 is substantially identical to the housing 100 except for the manner in which it achieves the different-pluggability feature, as will be described below in detail with reference to FIGS. 9A-11.

Like the housings 20, 100 and 120, the housing 140 houses and completely encapsulates the optical repeater 1 (FIGS. 1A-1D) and the leadframe 10 except for ends of the power and ground leads 10d, 10e, 10h, and 10i. The data leads 10c and 10g, which carry the aforementioned electrical signals, are also completely encapsulated in the housing 140. Thus, there is no way for an unauthorized person to gain access to these electrical signals without breaking apart the housing 140. To provide EMI shielding, the housing 140 is typically made of a hard plastic material that is either an electrically-conductive plastic material or an electrically-nonconductive plastic material having a metal EMI shielding part embedded therein.

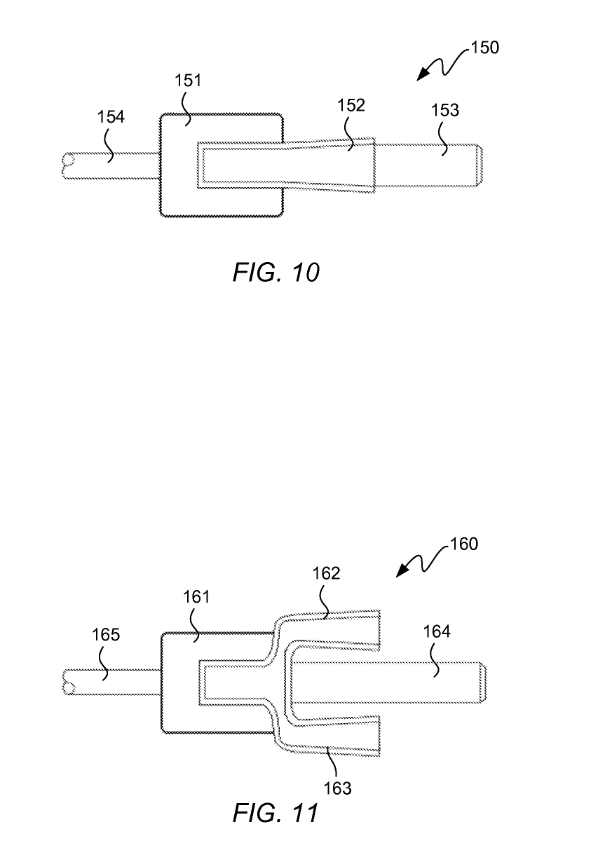

FIGS. 10 and 11 illustrate top plan views of first and second optical connectors 150 and 160, respectively, that are designed, or configured, to mate with receptacles 101 and 102, respectively, of housing 140. The optical connector 150 has a plug body 151, a latch 152 centered on the plug body 151, a ferrule 153 extending from the plug body 151, and an optical fiber cable 154 connected to the plug body 151. The optical connector 160 has a plug body 161, first and second latches 162 and 163 disposed on opposite sides of the plug body 161, a ferrule 164 extending from the plug body 161, and an optical fiber cable 165 connected to the plug body 161.

In accordance with this illustrative embodiment, the different-pluggability feature of the housing 140 is achieved by providing latch-mating and latch-blocking features 143 and 144, respectively, adjacent receptacle 101 and latch-mating and latch-blocking features 145 and 146, respectively, adjacent receptacle 102. The latch-mating feature 143 is an opening formed in the top surface of the housing 140 that is complementary in shape and size to the shape and size of a latching mechanism disposed on the bottom of latch 152 of the optical connector 150 (FIG. 10). The latch 152 of optical connector 150 may be identical to the latch 114 of the optical connector 110, and the latching mechanism of latch 152 may be identical to the latching mechanism 114a of latch 114.

When the optical connector 150 is mated with the receptacle 101, the latching mechanism disposed on latch 152 mates with the opening 143. The latch-blocking feature 144 is a pair of upwardly-directed stops 144a and 144b disposed on opposite sides of the opening 143. If an attempt is made to mate the optical connector 160 with the receptacle 101, the latches 162 and 163 will abut the stops 144a and 144b, respectively, thereby preventing the optical connector 160 from successfully mating with the receptacle 101. Therefore, receptacle 101 will successfully mate with optical connector 150, but will not successfully mate with optical connector 160.

The latch-blocking feature 146 is a single upwardly-directed stop. The latch-mating feature 145 is a pair of openings 145a and 145b formed in the top surface of the housing 140 and disposed on opposite sides of the stop 146. The openings 145a and 145b are identical in shape and size and are complementary in shape and size to the shape and size of respective latching mechanisms disposed on the bottom ends of the latches 162 and 163 of optical connector 160. When the optical connector 160 is mated with the receptacle 102, latching mechanisms disposed on the bottom ends of the respective latches 162 and 163 mate with the openings 145a and 145b, respectively. If an attempt is made to mate the optical connector 150 with the receptacle 102, the latch 152 will abut the stop 146, thereby preventing the connector 150 from successfully mating with the receptacle 102. Therefore, receptacle 102 will successfully mate with optical connector 160, but will not successfully mate with optical connector 150.

The foregoing illustrative embodiments are examples of VL-type housings that each have multiple receptacles with different-pluggability features for enabling the mating of the receptacles with different types of optical connectors. If should be noted, however, that the different-pluggability features can be achieved in virtually an infinite number of ways. The different-pluggability features that are employed will also vary depending on the configurations of the optical connectors that are to be mated with the receptacles. Therefore, the invention is not limited with respect to the manner in which the different-pluggability features are implemented or with respect to the optical connectors that are used with the receptacles. Also, although the housings 100, 120 and 140 are VL-type housings, this is not a requirement. The housings that are provided with the different-pluggability features can be any types of housings having multiple receptacles for mating with differently-configured optical connectors.

It should also be noted that while the housings 100, 120 and 140 have been described with regard to their use in housing the optical repeater 1, the housings 100, 120 and 140 may be used to house any type of optical communications device or system that needs to be interfaced with multiple optical connectors. For example, the housings 100, 120 and 140 may be used to house an optical transceiver module that converts electrical data signals into optical data signals to be transmitted over one of the optical fiber cables and that receives optical data signals over the other optical fiber cable and converts them into electrical data signals.

It should be noted that the invention has been described with respect to illustrative embodiments for the purpose of describing the principles and concepts of the invention. The invention is not limited to these embodiments. For example, although the repeater 1 has been described as having a particular physical configuration, many modifications can be made to the configuration within the scope of the invention. Also, although the repeater 1 has been described as having particular components, the repeater 1 can have other components, as will be understood by those of skill in the art. These and other modifications may be made to the embodiments described herein, and such modifications are within the scope of the invention, as will be understood by those of skill in the art.

What is claimed is:

1. An optical repeater comprising:
a bent leadframe having a first leadframe portion and a second leadframe portion that are interconnected by a bend formed in the leadframe, the first leadframe portion facing a front side of the repeater, the second leadframe portion facing a back side of the repeater;
at least a first optical-to-electrical (OE) converter mounted on the first leadframe portion;
at least a first electrical-to-optical (EO) converter mounted on the second leadframe portion;
a first optical port secured to the first leadframe portion and facing the front side of the repeater, the first optical port for receiving a first optical signal passing out of an end of a first optical fiber cable and directing the first optical signal onto the first OE converter, the first OE converter converting the first optical signal into a first electrical signal and outputting the first electrical signal over a data lead of the bent leadframe;
a second optical port secured to the second leadframe portion and facing a back side of the repeater, wherein the first EO converter device receives the first electrical signal via the data lead and converts the first electrical signal into a second optical signal, the second optical port directing the second optical signal into an end of a second optical fiber cable.

2. The optical repeater of claim 1, wherein the front side and back side of the repeater face opposite directions, the optical repeater further comprising:
a housing that houses most of the first and second leadframe portions, the first OE and EO converters, and the first and second optical ports, and wherein the housing renders the data lead inaccessible from outside of the housing, thereby preventing unauthorized access to electrical signals being carried on the data lead.

3. The optical repeater of claim 1, wherein the first and second leadframe portions are parallel to one another.

4. The optical repeater of claim 3, further comprising:
first and second plastic parts encapsulating at least portions of the first and second leadframe portions, respectively, and entirely encapsulating the EO converter and the OE converter.

5. The optical repeater of claim 4, wherein the first and second optical ports are integrally formed in the first and second plastic parts, respectively, and wherein the first and second plastic parts are transparent to an operating wavelength of the OE converter and to an operating wavelength of the EO converter, respectively.

6. The optical repeater of claim 5, wherein the first leadframe portion comprises a first power lead and a first ground lead, and wherein ends of the first power lead and the first ground lead are external to the first plastic part, and wherein the second leadframe portion comprises a second power lead and a second ground lead, and wherein ends of the second power lead and the second ground lead are external to the second plastic part.

7. The optical repeater of claim 2, wherein the housing has first and second passageways, or receptacles, formed in opposite sides thereof for allowing the ends of the first and second optical fiber cables to be passed through the housing and connected with first and second openings of the first and second optical ports, respectively.

8. The optical repeater of claim 7, wherein the housing is made of a plastic material.

9. The optical repeater of claim 8, wherein the plastic material is an electrically-conductive plastic material to provide the optical repeater with electromagnetic interference (EMI) shielding.

10. The optical repeater of claim 8, wherein the plastic material is an electrically-nonconductive plastic material and wherein a metal shielding part is embedded in the housing to provide the optical repeater with electromagnetic interference (EMI) shielding.

11. The optical repeater of claim 6, wherein the ends of the first power lead and the first ground lead are external to the housing, and wherein the ends of the second power lead and the second ground lead are external to the housing.

12. The optical repeater of claim 7, wherein the ends of the first and second optical fiber cables are connectorized ends having first and second optical connectors secured thereto, respectively, the first and second openings of the first and second optical ports being shaped and sized to receive ends of respective ferrules of the first and second optical connectors, respectively.

13. The optical repeater of claim 12, wherein the first and second receptacles have first and second pairs of flexible arms that define respective openings of the first and second receptacles, wherein the arms of each pair have ends that are designed to grip respective ridges disposed on the ferrules of the first and second optical connectors.

14. The optical repeater of claim 12, wherein the first and second optical connectors have different physical configurations and wherein the housing has first and second different-pluggability features for the first and second receptacles, respectively, wherein the first different-pluggability feature allows the first optical connector to be mated with the first receptacle, and wherein the second different-pluggability feature prevents the first optical connector from mating with the second receptacle.

15. The optical repeater of claim 14, wherein the first different-pluggability feature includes an opening formed in a top surface of the housing adjacent the first receptacle for mating with a latching mechanism of a first latch of the first optical connector.

16. The optical repeater of claim 15, wherein the second different-pluggability feature includes an upwardly-directed stop disposed on the top surface of the housing adjacent the second receptacle for abutting the first latch of the first optical connector if an attempt is made to mate the first optical connector with the second receptacle.

17. The optical repeater of claim 12, wherein the first and second optical connectors have different physical configurations and wherein the housing has first and second different-pluggability features for the first and second receptacles, respectively, wherein the first different-pluggability feature allows the first optical connector to be mated with the first receptacle, and wherein the second different-pluggability feature allows the second optical connector to be mated with the second receptacle, but prevents the first optical connector from mating with the second receptacle.

18. The optical repeater of claim 17, wherein the first different-pluggability feature includes a first opening of a first width formed in a top surface of the housing adjacent the first receptacle for mating with a first latching mechanism of a first latch of the first optical connector, wherein the first opening is complementary in shape and size to a shape and size of the first latching mechanism to enable the first latching mechanism to mate with the first opening if the first optical connector is mated with the first receptacle.

19. The optical repeater of claim 18, wherein the second different-pluggability feature includes first and second upwardly-directed stops disposed on the top surface of the housing adjacent the second receptacle, wherein the first and second stops are separated from one another by a second opening formed in the top surface of the housing adjacent the second receptacle, wherein the second opening has a width that is smaller than the width of the first opening and smaller than the width of the first latch such that if an attempt is made to mate the first optical connector with the second receptacle, the first latch will abut at least one of the first and second upwardly-directed stops to prevent the first optical connector from mating with the second receptacle.

20. The optical repeater of claim 19, wherein the second optical connector has a second latch having a second latching mechanism having a width that is smaller than the width of the second opening to enable the second latching mechanism to mate with the second opening.

21. The optical repeater of claim 17, wherein the first different-pluggability feature includes a first latch-mating feature and a first latch-blocking feature, the first latch-mating feature including a first opening of a first width formed in a top surface of the housing adjacent the first receptacle for mating with a first latching mechanism of a first latch of the first optical connector, the first latch-blocking feature including first and second upwardly-directed stops disposed on the top surface of the housing on opposite sides of the first opening, wherein the first opening is complementary in shape and size to a shape and size of the first latching mechanism to enable the first latching mechanism to mate with the first opening if the first optical connector is mated with the first receptacle.

22. The optical repeater of claim 21, wherein the second different-pluggability feature includes a second latch-mating feature and a second latch-blocking feature, the second latch-mating feature including second and third openings of a second width formed in the top surface of the housing adjacent the second receptacle for mating with second and third latching mechanisms of second and third latches, respectively, of the second optical connector, the second latch-blocking feature including a third upwardly-directed stop disposed on the top surface of the housing in between the second and third openings, wherein the third upwardly-directed stop will abut the first latch of the first optical connector if an attempt is made to mate the first optical connector with the second receptacle to thereby prevent the first optical connector from mating with the second receptacle.

23. A housing for housing at least one optical communications device, the housing comprising:
a first passageway, or receptacle, formed in a first side of the housing for allowing an end of a first optical fiber cable to be passed through the housing and connected with a first optical port of said at least one optical communications device;
a second passageway, or receptacle, formed in a second side of the housing for allowing an end of a second optical fiber cable to be passed through the housing and connected with a second optical port of said at least one optical communications device, wherein the first and second receptacles have first and second different-pluggability features, respectively, wherein the first different-pluggability feature allows the first optical connector to be mated with the first receptacle, and wherein the second different-pluggability feature prevents the first optical connector from mating with the second receptacle.

24. The housing of claim 23, wherein the first different-pluggability feature includes an opening formed in a top surface of the housing adjacent the first receptacle for mating with a first latching mechanism of a first latch of the first optical connector.

25. The housing of claim 24, wherein the second different-pluggability feature includes an upwardly-directed stop disposed on the top surface of the housing adjacent the second receptacle for abutting the first latch of the first optical connector if an attempt is made to mate the first optical connector with the second receptacle.

26. The housing of claim 23, wherein the first different-pluggability feature allows the first optical connector to be mated with the first receptacle, but prevents the second optical connector from mating with the first receptacle, and wherein the second different-pluggability feature allows the second optical connector to be mated with the second receptacle, but prevents the first optical connector from mating with the second receptacle.

27. The housing of claim 23, wherein the first different-pluggability feature includes a first opening of a first width formed in a top surface of the housing adjacent the first receptacle for mating with a first latching mechanism of a first latch of the first optical connector, wherein the first opening is complementary in shape and size to a shape and size of the first latching mechanism to enable the first latching mechanism to mate with the first opening if the first optical connector is mated with the first receptacle.

28. The housing of claim 27, wherein the second different-pluggability feature includes first and second upwardly-directed stops disposed on the top surface of the housing adjacent the second receptacle, wherein the first and second stops are separated from one another by a second opening formed in the top surface of the housing adjacent the second receptacle, the second opening having a width that is smaller than the width of the first opening and smaller than the width of the first latch such that if an attempt is made to mate the first optical connector with the second receptacle, the first latch will abut at least one of the first and second upwardly-directed stops to prevent the first optical connector from mating with the second receptacle.

29. The housing of claim 28, wherein the second optical connector has a second latch having a second latching mechanism having a width that is smaller than the width of the second opening to enable the second latching mechanism to mate with the second opening.

30. The housing of claim 26, wherein the first different-pluggability feature includes a first latch-mating feature and a first latch-blocking feature, the first latch-mating feature including a first opening of a first width formed in a top surface of the housing adjacent the first receptacle for mating with a first latching mechanism of a first latch of the first optical connector, the first latch-blocking feature including first and second upwardly-directed stops disposed on the top surface of the housing on opposite sides of the first opening, wherein the first opening is complementary in shape and size to a shape and size of the first latching mechanism to enable the first latching mechanism to mate with the first opening if the first optical connector is mated with the first receptacle.

31. The optical repeater of claim 30, wherein the second different-pluggability feature includes a second latch-mating feature and a second latch-blocking feature, the second latch-mating feature including second and third openings of a second width formed in the top surface of the housing adjacent the second receptacle for mating with second and third latching mechanisms of second and third latches, respectively, of the second optical connector, the second latch-blocking feature including a third upwardly-directed stop disposed on the top surface of the housing in between the second and third openings, wherein the third upwardly-directed stop will abut the first latch of the first optical connector if an attempt is made to mate the first optical connector with the second receptacle to thereby prevent the first optical connector from mating with the second receptacle.

32. An integrally-formed plastic housing for housing at least one optical communications device, the housing comprising:
a first receptacle formed in a first side of the housing for allowing a first optical connector to be connected to the first receptacle, the first optical connector being secured to an end of a first optical fiber cable, the first receptacle including first and second flexible arms having first and second ends for engaging a first ridge feature of a first ferrule of the first optical connector; and
a second receptacle formed in a second side of the housing for allowing a second optical connector to be connected to the second receptacle, the second optical connector being secured to an end of a second optical fiber cable, the second receptacle including third and fourth flexible arms having third and fourth ends for engaging a second ridge feature of a second ferrule of the second optical connector.

33. The integrally-formed plastic housing of claim 32, further comprising:
first and second different-pluggability features, respectively, wherein the first different-pluggability feature allows the first optical connector to be mated with the first receptacle, and wherein the second different-pluggability feature prevents the first optical connector from mating with the second receptacle.
